(19) United States
(12) Patent Application Publication
(10) Pub. No.: US 2009/0203233 A1
(43) Pub. Date: Aug. 13, 2009

(54) Devices For Providing An Electrical Connection To A Rotating Shaft In An Image Forming Device

(76) Inventors: Jarrett C. Gayne, Lexington, KY (US); James John Molloy, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/771,291

(22) Filed: Jun. 29, 2007

(51) Int. Cl. H01R 39/00

(52) U.S. Cl. 439/27

(57) ABSTRACT

The present application is directed to devices for maintaining an electrical connection to a rotating shaft of an image forming device. One embodiment of a device to provide an electrical connection to the shaft of a developer roller may include a high voltage power supply electrically connected to the shaft. The electrical connection may be made through an annular electrical connector. The annular electrical connector may be positioned on and rotates with the shaft.

### BACKGROUND

The present application is directed to devices for providing electrical connections in an image forming device and more specifically to providing electrical connections for rotating shafts within the image forming device.

Image forming devices, such as a color laser printer, facsimile machine, copier, all-in-one device, etc, typically use an electrophotographic image forming process. A photoconductive surface, such as a drum, roller, or belt, is uniformly charged to a first voltage level. A latent image is then formed on the photoconductive surface by incident optical energy, such as a laser beam. The latent image is developed by applying toner to the photoconductive surface. The toner is typically applied by a developer roller, the surface of which is charged to a second voltage, with toner electrostatically adhered thereto. The toner is electrostatically transferred from the developer roller to the latent image on the photoconductive surface by the voltage difference between the developer roller surface and the latent image area on the photoconductive surface.

The design of image forming devices often includes removable cartridge units that contain a number of components that receive an electric charge. A recurring challenge in the design of removable cartridge units for image forming devices is the provision of electrical contacts for biasing rotating components such as the photoconductive drum and developer roller surfaces to their required voltages, or in grounding these elements. These contacts should provide reliable electrical connectivity, but minimize the complexity of cartridge units, fit in restricted spaces, and require simple maintenance procedures. Additionally, electrical contacts may be necessary for a toner-adder roller, transfer roller, and charge roller.

### SUMMARY

The present application is directed to devices for maintaining an electrical connection to a rotating shaft of an image forming device. One embodiment of a device to provide an electrical connection to the shaft of a developer roller may include a high voltage power supply electrically connected to the shaft. The electrical connection may be made through an annular electrical connector alone or in conjunction with a bearing. The annular electrical connector may be positioned on and rotates with the shaft.

### BRIEF DESCRIPTION OF THE DRAWINGS

FIG. 1 is a schematic view of an electrical connector operatively connecting a shaft and a power supply according to one embodiment.

FIG. 2 is side view of a developer roller assembly with an annular electrical connector according to one embodiment.

FIG. 3 is a perspective view of a shaft and bearing according to one embodiment.

FIG. 4 is a partial side view of a shaft and bearing according to one embodiment.

FIG. 5 is an end view of a shaft and drive gear according to one embodiment.

FIG. 6 is a front view of an annular electrical connector according to one embodiment.

FIG. 7 is a schematic side view of an annular electrical connector according to one embodiment.

FIG. 8 is a side view of a developer roller assembly and annular electrical connectors according to one embodiment.

FIG. 9 is a front view of an annular electrical connector according to one embodiment.

FIG. 10 is a front view of an annular electrical connector according to one embodiment.

FIG. 11 is a schematic side view of an annular electrical connector according to one embodiment.

FIG. 12 is a schematic side view of an annular electrical connector according to one embodiment.

FIG. 13 is a front view of an annular electrical connector according to one embodiment.

FIG. 14 is a perspective view of a developer roller, shaft, and an annular electrical connector according to one embodiment.

FIG. 15 is a perspective view of developer roller, bearing, shaft, and annular electrical connector according to one embodiment.

FIG. 16 is a perspective view of a developer roller and shaft with an annular electrical connector according to one embodiment.

FIG. 17 is a front view of a bearing with a nonconductive insert according to one embodiment.

FIG. 18 is a side view of a bearing with a nonconductive insert according to one embodiment.

### DETAILED DESCRIPTION

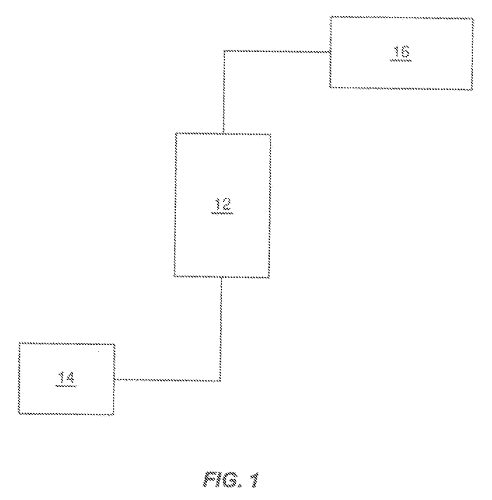

The present application is directed to devices for maintaining an electrical connection to a rotating shaft of an image forming device. One embodiment of a device to provide an electrical connection to a shaft 16 of a developer roller 20 is illustrated schematically in FIG. 1. A high voltage power supply 14 is electrically connected to the shaft 16. The electrical connection may be made through an annular electrical connector 12 alone or in conjunction with an electrically conductive bearing 18. The annular electrical connector 12 may be positioned on and rotate with the shaft 16.

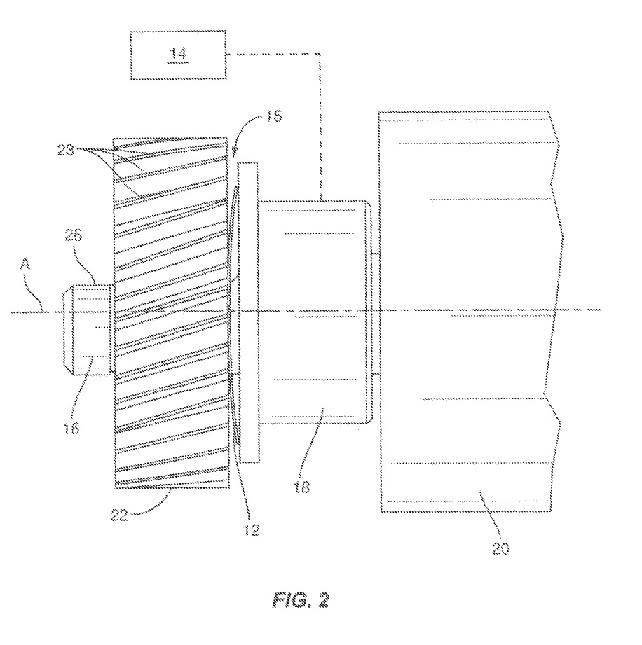

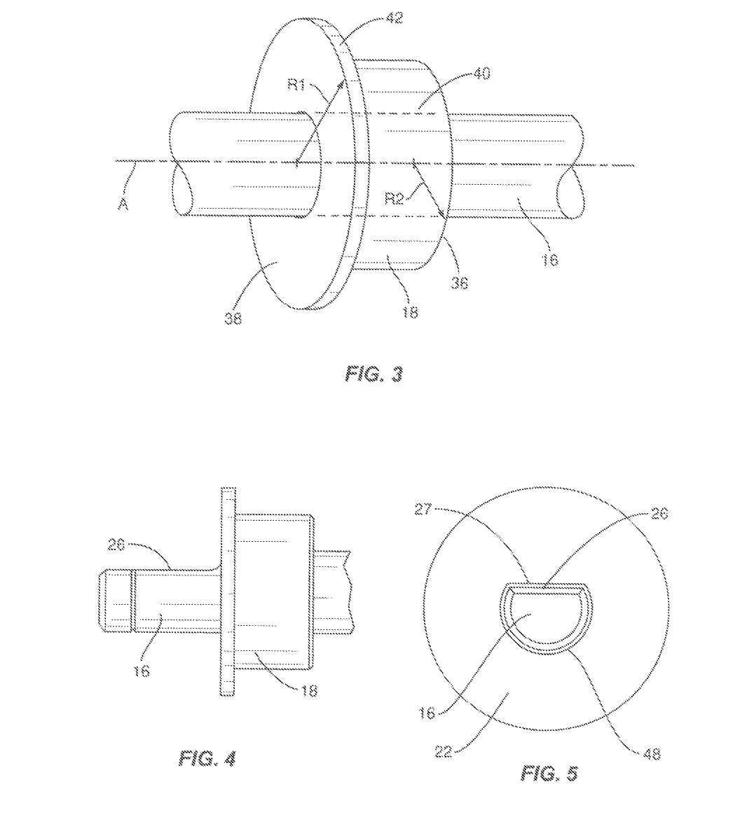

FIG. 2 illustrates one embodiment of an end of the developer roller 20 of the image forming device. An exemplary image forming device is disclosed in U.S. Pat. Nos. 7,162,182 and 6,510,291, and Model No. C762 available from Lexmark International, Inc. of Lexington, Ky. the disclosures of which are incorporated herein by reference. The developer roller 20 includes the shaft 16 with a longitudinal axis A. The shaft 16 extends axially a distance beyond the end of the developer roller 20. The bearing 18 and a drive gear 22 may be positioned on the shaft 16. The bearing 18 and the drive gear 22 are spaced apart from one another defining a gap 15 therebetween. The bearing 18 may be electrically connected to the power supply 14. The annular electrical connector 12 may be positioned on the shaft 16 in the gap 15 between the bearing 18 and the drive gear 22. The bearing 18, drive gear 22, and annular electrical connector 12 are positioned so that a longitudinal axis of each coincides with axis A of the shaft 16.

As illustrated in the embodiment of FIGS. 2 and 3, the bearing 18 includes a distal end 36 that is positioned adjacent to the developer roller 20 and a proximal end 38. An opening 40 extends through the bearing 18 between the distal and proximal ends 36, 38 along the longitudinal axis A. The opening 40 and the shaft 16 are cooperatively configured such that the shaft 16 is free to rotate when inserted into the opening 40. When the shaft 16 is fully inserted into the opening 40, a portion of the shaft 16 extends beyond the proximal end 38 of the bearing 18. The bearing 18 may include a flange 42 extending radially outward at the proximal end 38. The flange 42 is configured such that a radius R1 extending from the longitudinal axis A to an outer edge of the proximal end 38 is greater than a radius R2 extending from the longitudinal axis A to an outer edge of the distal end 36.

In the embodiment of FIG. 2, the drive gear 22 is positioned on the portion of the shaft 16 extending beyond the proximal end 38 of the bearing 18. The drive gear 22 and the shaft 16 include a mating geometry that allows the drive gear 22 to transmit a rotational force to the shaft 16. In one embodiment, this mating geometry is a D-shape cross-sectional shape as illustrated in FIGS. 4 and 5. The portion of the shaft 16 extending beyond the proximal end 38 of the bearing 18 includes a flat 26 formed by removing a longitudinal portion of an outer surface of the shaft 16. As illustrated in an end view of the shaft 16 in FIG. 5, the flat 26 creates a D-shaped axial cross-sectional shape. The drive gear 22 includes a central aperture 48 that runs axially through the drive gear 22 and conforms to the D-shaped mating geometry. The central aperture 48 includes a surface 27 that cooperates with flat 26 when the drive gear 22 is positioned on the shaft 16. The drive gear 22 may be held in place on the shaft 16 by interference fit, a screw, a pin, a locking tab protruding from the outer surface of the shaft, or other embodiments known in the art. In an embodiment where the drive gear 22 is a helical gear, forces on helical gear teeth 23 may act in a direction to push the drive gear 22 towards the bearing 18, reducing the gap 15 and negating the need to hold the drive gear 22 in place on the shaft 16. As the gap 15 is reduced, the annular electrical connector 12 may be compressed.

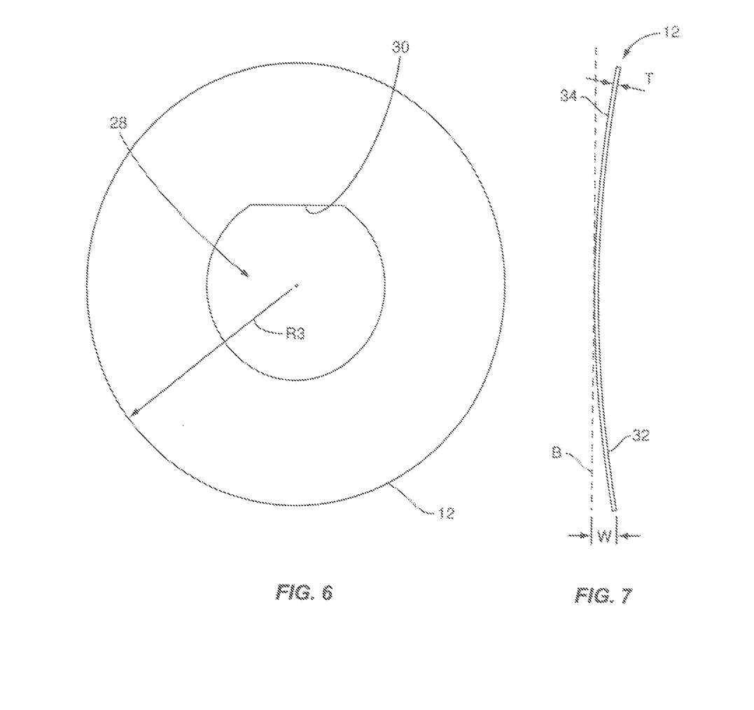

The annular electrical connector 12 in one embodiment as illustrated in FIG. 6 includes a generally circular shape with a radius R3. The radius R3 is selected to be smaller than the radius R1 of the proximal end of the bearing 18. In one embodiment, R3 is also smaller than R2. As illustrated by the side view in FIG. 7, the annular electrical connector 12 may be formed with a generally continuous curve defining a concave surface 32 and a convex surface 34. The width W of the annular electrical connector 12 is defined by an amount that an edge of the annular electrical connector deviates from a plane B. The width is selected such that it is greater than the gap 15 between the bearing 18 and the drive gear 22.

In one embodiment, the annular electrical connector 12 includes the same mating geometry as the drive gear 22. FIG. 6 illustrates the annular electrical connector 12 with a D-shaped central aperture 28. The central aperture 28 includes a flat surface 30 that cooperates with flat 26 of the shaft 16 as illustrated in FIG. 4. Thus, the annular electrical connector 12 rotates with the shaft 16. In another embodiment, the annular electrical connector 12 includes a mating geometry different than the drive gear 22. For example, the annular electrical connector 12 may have a rectangular mating geometry and the drive gear 22 may have a D-shaped mating geometry as described above. Other embodiments may include a variety of other mating geometries for the annular electrical connector 12, such as a key and slot, two opposing flats, a spline, or interference fit.

As illustrated in FIG. 2, the annular electrical connector 12 may be positioned on the shaft 16 in the gap 15 between the bearing 18 and drive gear 22 with the convex surface 34 towards the end of the shaft 16. Because the gap 15 is smaller than the width W of the annular electrical connector 12, the drive gear 22 exerts a force on the annular electrical connector 12. The proximal side 38 of the bearing 18 exerts a restraining force against the annular electrical connector 12. These forces may act together to compress the annular electrical connector 12 from a first width W to a second, smaller width W. Thus, the annular electrical connector 12 may assume a position approaching a flattened state of plane B. The compressive force serves to maintain contact between the annular electrical connector 12 and the bearing 18. Thus, the annular electrical connector 12 maintains an electrical contact between the bearing 18 and the shaft 16 that may be present if a direct electrical contact between the bearing 18 and the shaft 16 is lost.

In order to allow the annular electrical connector 12 to compress within the gap 15, the annular electrical connector may be formed of a resilient material and have a thickness selected to allow an amount of flexibility. Embodiments include thicknesses ranging from about 0.05 mm to about 0.5 mm. In another embodiment, the thickness T may be greater than illustrated in FIG. 7 to provide greater durability. As the thickness T increases, the flexibility may decrease. In an embodiment where the thickness is selected such that the annular electrical connector 12 has very little flexibility, the width W approximates the gap 15.

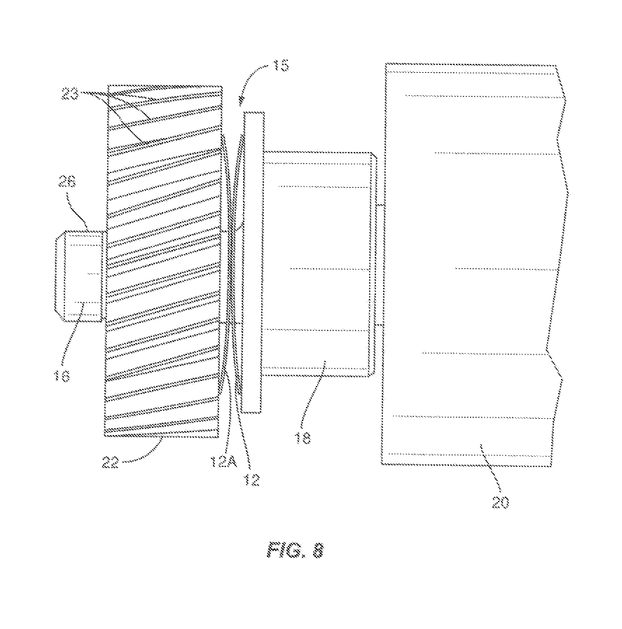

In another embodiment, more than one annular electrical connector 12 may be used in combination. As illustrated in FIG. 8, two annular electrical connectors 12, 12A may be positioned in the gap 15. In this embodiment, the annular electrical connectors 12, 12A are positioned with the convex surfaces 34 in contact with one another. Although not shown, it is understood that the annular electrical connectors 12, 12A may be positioned with the concave surfaces 32 in contact with one another. It is further understood that the annular electrical connectors 12, 12A may be positioned similarly and nested within one another such that the concave surface 32 of one is in contact with the convex surface 34 of the other.

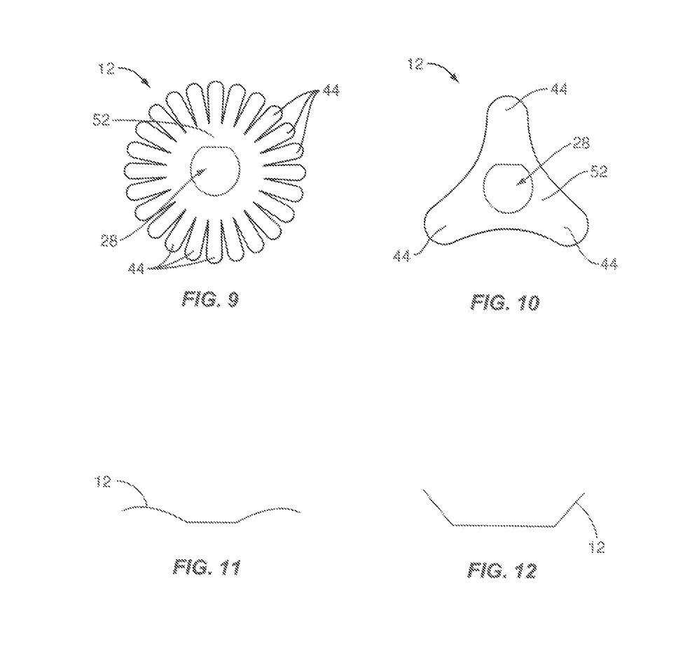

While the embodiments of the annular electrical connector 12 described above include a generally circular shape as illustrated in the top view of FIG. 6 with a single, continuous curvature as illustrated in FIG. 7, other configurations are anticipated. FIG. 9 illustrates an annular electrical connector 12 with a body portion 52 and a plurality of contact arms 44 extending outward from the body portion 52. FIG. 10 illustrates an embodiment with a tripod configuration with three contact arms 44 extending from the body portion 52. FIG. 11 illustrates a cross-sectional view of an embodiment of the annular electrical connector 12 with multiple curves, and FIG. 12 illustrates an embodiment with an angular configuration. A variety of shapes and curvatures may be selected to suit a particular purpose.

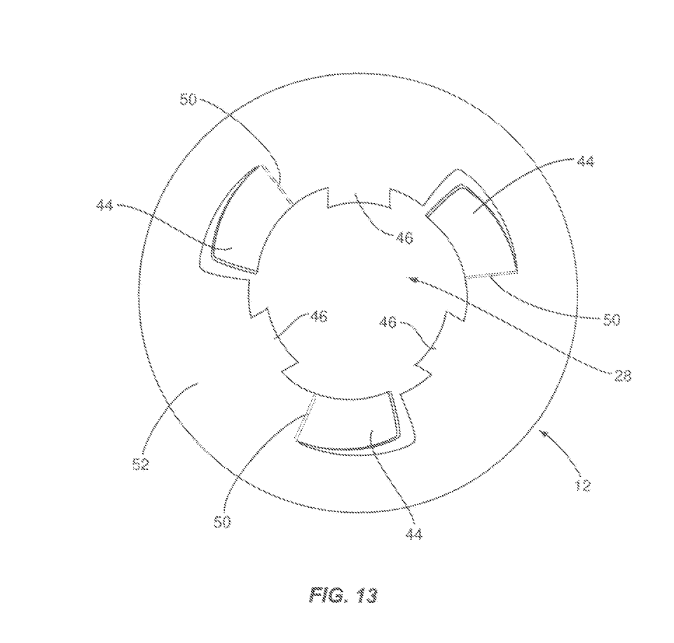

In the embodiments described above, the annular electrical connector 12 relies on a mating geometry to transfer rotational movement from the shaft 16, as well as a curved or non-planar shape that may be compressed within the gap 15 to maintain contact with the bearing 18. FIG. 13 illustrates another embodiment of the annular electrical connector 12 that does not require a particular mating geometry, nor does it require another part (e.g., the drive roller 22) to maintain contact with the bearing 18. The annular electrical connector 12 includes a body portion 52 and a plurality of securing tabs 46 defining an aperture 28 therebetween. This embodiment also includes a plurality of contact arms 44 integrally formed with the body portion 52 and extending outward from the body portion 52 at crease 50. The shaft 16 may be inserted into the aperture 28 such that the securing tabs 46 contact the shaft 16. The annular electrical connector 12 may then be positioned on the shaft 16 such that the contact arms 44 make contact with the bearing 18 as described in detail below.

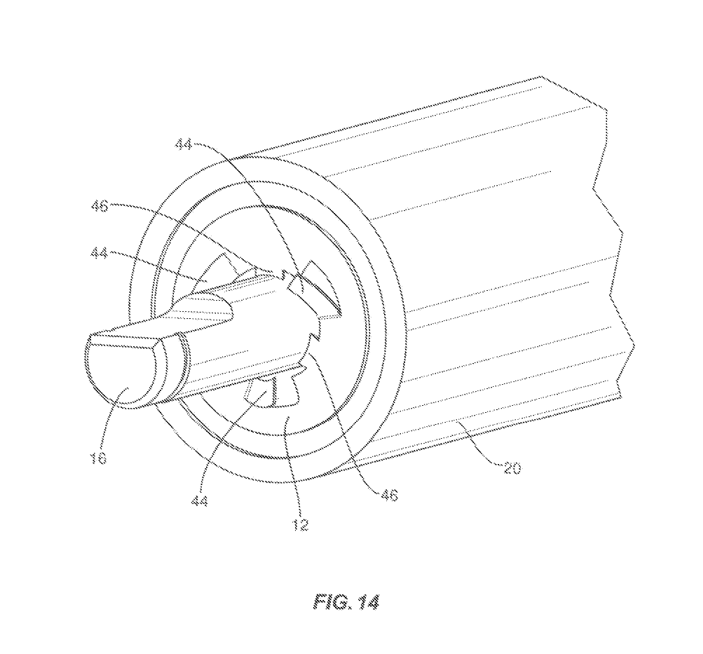

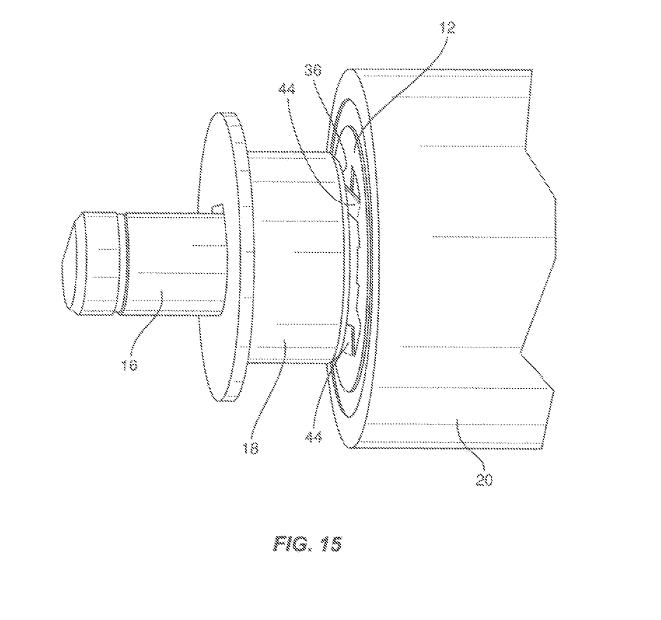

In the embodiments described above, the annular electrical connector 12 is positioned in the gap 15 between the bearing 18 and the drive gear 22. These embodiments of the annular electrical connector 12 may also be positioned between the bearing 18 and the developer roller 20. FIG. 13 illustrates another embodiment of an annular electrical connector 12 adapted for placement between the bearing 18 and the developer roller 20. The annular electrical connector 12 is first positioned on the shaft 16 adjacent to the developer roller 22 as illustrated in FIG. 14. The securing tabs 46 secure the annular electrical connector 12 in position on the shaft 16 so that the annular electrical connector 12 rotates with the shaft 16. The annular electrical connector 12 is further positioned such that the contact arms 44 extend away from the developer roller 22 generally in the axial direction of the shaft 16. As illustrated in FIG. 15, the bearing 18 is then positioned on the shaft 16 so that the contact arms 44 contact the distal end 36 of the bearing 18.

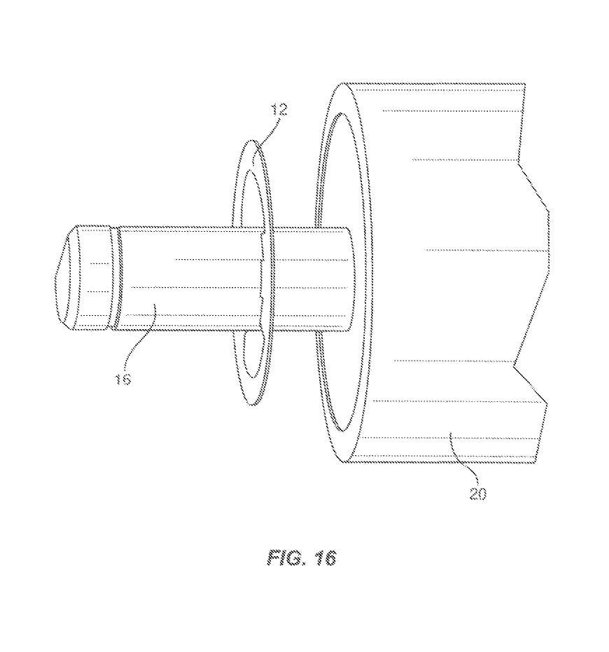

In another embodiment illustrated in FIG. 16, the annular electrical connector 12 may be used on a shaft 16 without a bearing 18 or drive gear 22. In this embodiment, the annular electrical connector 12 typically includes an interference fit with the shaft 16 as described in detail above. The annular electrical connector 12 is generally planar, as no curvature is necessary to contact the bearing 18.

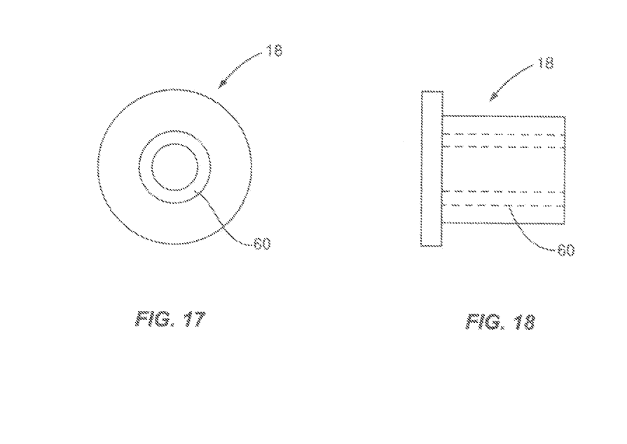

In one embodiment, the bearing 18 includes a nonconductive insert 60 as illustrated in FIGS. 17 and 18. The insert 60 makes contact with the shaft 16 and may provide reduced friction or wear at an interface between the bearing 18 and the shaft 16. In this embodiment, the annular electrical connector 12 provides a conductive path from the bearing 18 to the shaft 16.

The annular electrical connector 12 may be constructed from a variety of electrically conductive materials such as steel, copper, brass, aluminum, beryllium copper, phosphor bronze, or conductive plastic. In addition, the annular electrical connector 12 may be formed of an electrically conductive materially plated with a second conductive material. Representative examples include nickel plated steel, chromium plated steel, nickel plated conductive plastic, or nickel plated phosphor bronze.

Each of the embodiments of the annular electrical connector 12 described above lends itself to retrofitting existing developer rollers 20 as well as incorporation into new designs. The annular electrical connector 12 may be placed in an existing, relatively narrow space such as that between the bearing 18 and drive gear 22, and may require no additional mounting hardware. Thus, the annular electrical connector 12 may be installed on existing developer rollers 20 with little or no modification. The annular electrical connector 12 may be used with other rollers within the image forming device that require an electrical charge, such as photoconductive rollers, toner-adder rollers, transfer rollers, and charge rollers.

In one embodiment, the power supply 14 is electrically connected to the bearing 18. A first electrical path is formed from the power supply 14 to the outer surface of the bearing 18, through the body of the bearing 18 to an interface between the bearing 18 and the shaft 16, and finally to the shaft 16. A second electrical path is formed from the body of the bearing 18, through the annular electrical connector 12, and to the shaft 16. The second electrical path may provide a redundant electrical path to improve the reliability of the electrical connection to the shaft.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising”, and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

1-20. (canceled)

21. An apparatus, comprising:
a power source;
a rotating shaft;
a resilient electrical connector having a central aperture adapted to receive the rotating shaft therein and provide an electrical connection to the rotating shaft, the connector slidably engaging the rotating shaft, the electrical connector being substantially O-shaped having a first surface and an opposed second surface, a cross-section of the connector having a single, substantially continuous curve such that the first surface is concave and the second surface is convex, the connector being integrally formed as a single, unitary member;
a bearing having a central aperture for receiving the rotating shaft and having a first end with a surface which contacts the first surface of the connector so as to form an electrical connection therewith, the bearing being electrically coupled to the power source such that an electrical connection is formed between the shaft and the bearing via the connector; and
a driving means adapted to receive the shaft therein and disposed adjacent to the connector, the driving means exerting a compressing force on the electrical connector during rotation such that the resilient electrical connector is compressed by the driving means during rotation thereof.

22. The apparatus of claim 21, wherein the compressing force and a restraining force is applied to a convex surface and a concave surface of the resilient electrical connector respectively.

23. The apparatus of claim 21, wherein the central aperture of the connector includes at least one flat side to contact a corresponding flat surface of the rotating shaft and rotate therewith.

24. The apparatus of claim 23, wherein the at least one flat side provides electrical contact with the rotating shaft.

25. An apparatus for providing an electrical connection between a power source and a rotating shaft in an image forming device, the apparatus comprising:
a bearing adapted to receive the rotating shaft therein, the bearing being in electrical communication with the power source; and
an annular electrical connector including a generally planar shape, a body portion and a central aperture adapted to receive the shaft therein, the annular electrical connector positioned on the shaft adjacent to the bearing, the annual electrical connector including a plurality of tabs which extend into the central aperture and contact the shaft so as to provide an electrical connection therewith, the annual electrical connector further including at least one contact arm which extends outwardly from the body portion so as to contact the bearing and provide an electrical connection therewith such that an electrical connection is created between the bearing and the shaft through the annular electrical connector.

26. The apparatus of claim 25, wherein the at least one contact arm extends from the body portion along a crease.

27. The apparatus of claim 25, wherein the at least one contact arm comprises a plurality of contact arms disposed substantially uniformly about the central aperture, each contact arm extending from the body portion along a crease.
